(19) United States
(12) Patent Application Publication
(10) Pub. No.: US 2026/0298332 A1
(43) Pub. Date: Oct. 1, 2026

(54) SHIFT DEVICE

(71) Applicant: KABUSHIKI KAISHA TOKAI-RIKA-DENKI-SEISAKUSHO, Niwa-gun, Aichi (JP)

(72) Inventors: Yasuhiro OKA, Niwa-gun, Aichi (JP); Takuya SASAKI, Niwa-gun, Aichi (JP); Yoya OGAWA, Niwa-gun, Aichi (JP)

(73) Assignee: KABUSHIKI KAISHA TOKAI-RIKA-DENKI-SEISAKUSHO, Niwa-gun, Aichi (JP)

(21) Appl. No.: 19/476,538

(22) PCT Filed: Apr. 8, 2024
(86) PCT No.: PCT/JP2024/014317

§ 371 Date: Oct. 17, 2025

(30) Foreign Application Priority Data
Apr. 21, 2023 (JP) 2023-070457

(51) Int. Cl. F16H 59/02

(52) U.S. Cl. CPC F16H 59/02

(57) ABSTRACT

In a shift device, a rotating body is coupled to a lever, the rotational position of the rotating body is detected, and the shift position of the lever is detected. Here, when the rotating body is to be coupled to the lever, a regulating mechanism regulates the rotational position of the rotating body to an H rotational position in a state in which the lever is retained in an H position. For this reason, the need for a calibration process to match the rotational position of the rotating body that is detected and the shift position of the lever with each other can be eliminated.

### TECHNICAL FIELD

The present invention relates to a shift device in which the shift position of a shift body is detected.

### BACKGROUND ART

In the automotive transmission described in the specification of U.S. Patent Application Publication No. 2019/0195339, a lever and a magnet gear are coupled, and when the lever is pivoted, the magnet gear is rotated. Moreover, a detection sensor detects the rotational position of the magnet gear (the direction of the magnetic field generated by the magnet), whereby the shift position of the lever is detected.

Here, in this automotive transmission, after the lever and magnet gear have been coupled, a calibration process is needed to match the rotational position of the magnet gear detected by the detection sensor and the shift position of the lever with each other.

### SUMMARY OF INVENTION

### Technical Problem

In consideration of the above circumstances, it is an object of the present invention to obtain a shift device that can eliminate the need for a calibration process to match the moving position of a moving body detected by a detection mechanism and the shift position of a shift body with each other.

### Solution to Problem

A shift device of a first aspect of the invention includes: a shift body having a shift position that is changed when the shift body is moved; a moving body that is coupled to the shift body and that is moved as a result of the shift body being moved; a detection mechanism that detects a moving position of the moving body to thereby detect the shift position of the shift body; and a regulating mechanism that regulates the moving body to a moving position corresponding to the shift position of the shift body when the shift body and the moving body are coupled.

A shift device of a second aspect of the invention is the shift device of the first aspect of the invention, wherein when the shift body and the moving body have been coupled, regulation of the moving position of the moving body by the regulating mechanism is cancelled.

A shift device of a third aspect of the invention is the shift device of the first aspect or the second aspect of the invention, wherein the shift device includes an energizing mechanism that energizes the shift body to the shift position.

A shift device of a fourth aspect of the invention is the shift device of any one of the first aspect to the third aspect of the invention, wherein before the regulating mechanism regulates the moving position of the moving body, the moving body is guided to the moving position corresponding to the shift position of the shift body.

A shift device of a fifth aspect of the invention is the shift device of any one of the first aspect to the fourth aspect of the invention, wherein the shift device includes: first gear teeth that are provided at a shift body side and second gear teeth that are provided at a moving body side and that mesh with the first gear teeth, wherein the regulating mechanism regulates the moving body to the moving position corresponding to the shift position of the shift body so that one of the first gear teeth is disposed in a center between the second gear teeth or one of the second gear teeth is disposed in a center between the first gear teeth.

A shift device of a sixth aspect of the invention is the shift device of any one of the first aspect to the fifth aspect of the invention, wherein the shift device includes a detected portion that is positioned in the moving body and that is detected by the detection mechanism to detect the moving position of the moving body.

A shift device of a seventh aspect of the invention is the shift device of any one of the first aspect to the sixth aspect of the invention, wherein the moving body is rotated as a result of the shift body being moved.

### Advantageous Effects of Invention

In the shift device of the first aspect of the invention, when the shift body is moved, the shift position is changed. Furthermore, the shift body and the moving body are coupled, and the moving body is moved as a result of the shift body being moved. Moreover, the detection mechanism detects the moving position of the moving body to detect the shift position of the shift body.

Here, the regulating mechanism regulates the moving body to the moving position corresponding to the shift position of the shift body when the shift body and the moving body are coupled. For this reason, because the shift body and the moving body are coupled, the moving position of the moving body and the shift position of the shift body can be matched to each other, and the need for a calibration process to match the moving position of the moving body detected by the detection mechanism and the shift position of the shift body with each other can be eliminated.

In the shift device of the second aspect of the invention, when the shift body and the moving body have been coupled, the regulation of the moving position of the moving body by the regulating mechanism is cancelled. For this reason, the shift body can be moved to move the moving body.

In the shift device of the third aspect of the invention, the energizing mechanism energizes the shift body to the shift position. For this reason, while the energizing mechanism disposes the shift body in the shift position, the regulating mechanism can regulate the moving position of the moving body to couple the shift body and the moving body, and the moving position of the moving body and the shift position of the shift body can be easily matched to each other.

In the shift device of the fourth aspect of the invention, before the regulating mechanism regulates the moving position of the moving body, the moving body is guided to the moving position corresponding to the shift position of the shift body. For this reason, the regulating mechanism can easily regulate the moving body to the moving position corresponding to the shift position of the shift body.

In the shift device of the fifth aspect of the invention, the first gear teeth of the shift body side and the second gear teeth of the moving body side are meshed.

Here, the regulating mechanism regulates the moving body to the moving position corresponding to the shift position of the shift body so that one of the first gear teeth is disposed in the center between the second gear teeth or one of the second gear teeth is disposed in the center between the first gear teeth. For this reason, the precision of the match between the moving position of the moving body and the shift position of the shift body can be increased.

In the shift device of the sixth aspect of the invention, the detection mechanism detects the detected portion of the moving body to detect the moving position of the moving body.

Here, the detected portion is positioned in the moving body. For this reason, the positional precision of the detected portion in the moving body can be increased, and the precision of the match between the moving position of the moving body detected by the detection mechanism and the shift position of the shift body can be increased.

In the shift device of the seventh aspect of the invention, the moving body is rotated as a result of the shift body being moved. For this reason, the moving space of the moving body can be reduced.

### BRIEF DESCRIPTION OF THE DRAWINGS

FIG. 1 is a perspective view showing a shift device pertaining to an embodiment of the invention as viewed obliquely from the right rear.

FIG. 2A is a perspective view showing a circuit board and other parts in the shift device pertaining to the embodiment of the invention as viewed obliquely from the right rear.

FIG. 2B is a perspective view showing a rotating body and other parts in the shift device pertaining to the embodiment of the invention as viewed obliquely from the right rear.

FIG. 3A is a perspective view showing the rotating body and other parts of the shift device pertaining to the embodiment of the invention as viewed from the right side.

FIG. 3B is a perspective view showing a first gear and other parts of the shift device pertaining to the embodiment of the invention as viewed from the right side.

FIG. 4A is a perspective view showing the rotating body and other parts of the shift device pertaining to the embodiment of the invention as viewed obliquely from the right front.

FIG. 4B is a perspective view showing the rotating body of the shift device pertaining to the embodiment of the invention in the middle of being assembled as viewed obliquely from the right front.

FIG. 5A is a perspective view showing the rotating body of the shift device pertaining to the embodiment of the invention as viewed from the right side.

FIG. 5B is a perspective view showing the rotating body of the shift device pertaining to the embodiment of the invention as viewed obliquely from the right front.

FIG. 6A is a perspective view showing the rotating body of the shift device pertaining to the embodiment of the invention as viewed obliquely from the left front.

FIG. 6B is a perspective view showing the rotating body of the shift device pertaining to the embodiment of the invention as viewed obliquely from the lower left.

### DESCRIPTION OF EMBODIMENT

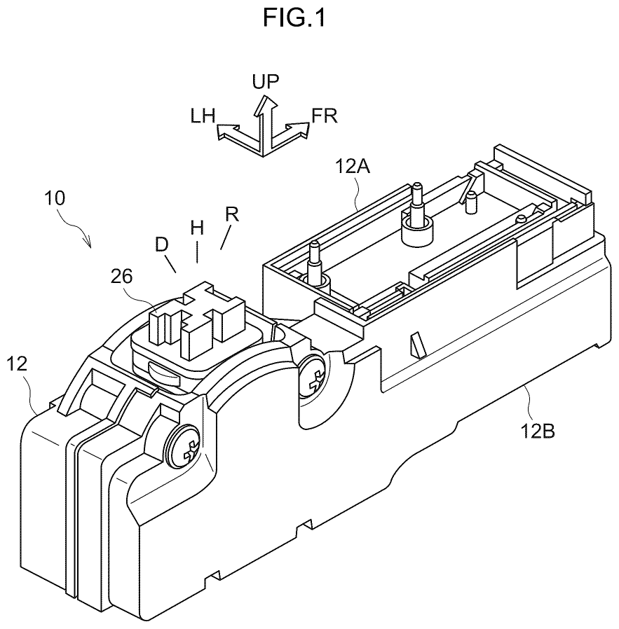

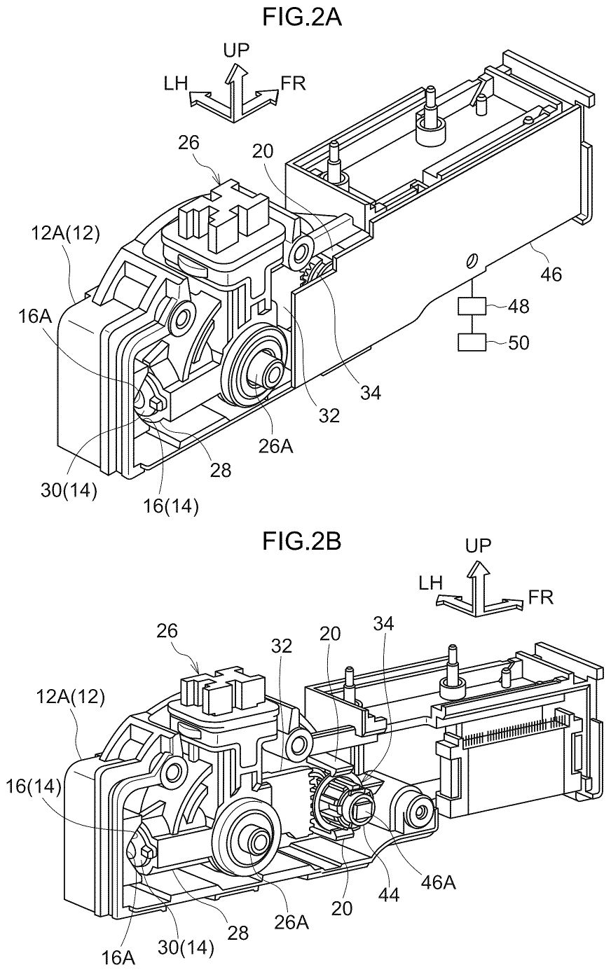

In FIG. 1 a shift device 10 pertaining to an embodiment of the invention is shown in a perspective view as viewed obliquely from the right rear, and in FIG. 2B the inside of the shift device 10 is shown in a perspective view as viewed obliquely from the right rear. It will be noted that in the drawings arrow FR indicates a forward direction of the shift device 10, arrow LH indicates a leftward direction of the shift device 10, and arrow UP indicates an upward direction of the shift device 10.

The shift device 10 pertaining to the present embodiment is installed in a console (not shown in the drawings) of a vehicle (automobile), and the forward direction, the leftward direction, and the upward direction of the shift device 10 are oriented to the forward direction, the leftward direction, and the upward direction of the vehicle, respectively.

As shown in FIG. 1 and FIG. 2B, the shift device 10 is provided with a plate 12 shaped like a substantially cuboidal box and serving as a support body, and the plate 12 is secured to the inside of the console. A left plate 12A is provided on the left side of the plate 12, a right plate 12B is provided on the right side of the plate 12, and the left plate 12A and the right plate 12B are assembled together in the left and right direction, whereby the plate 12 is configured.

On the rear end portion of the inside of the plate 12A, an energizing face 16 (moderating face) serving as an energized portion configuring an energizing mechanism 14 (moderating mechanism) is installed, and the energizing face 16 is rearwardly concave. The up and down direction central portion of the energizing face 16 is a retention face 16A, and the energizing face 16 is inclined in the forward direction heading outward in both up and down directions from the retention face 16A.

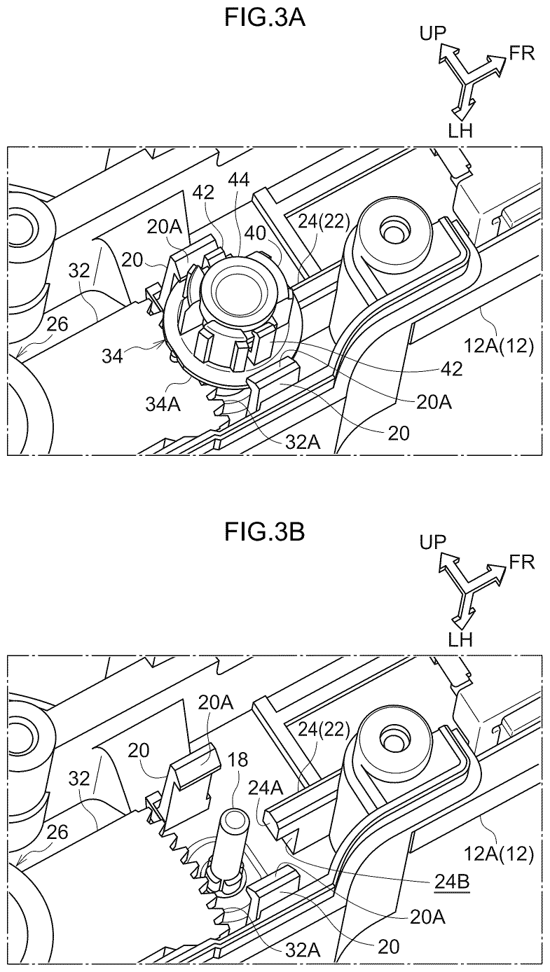

On the left wall of the plate 12 (the left wall of the left plate 12A), a support shaft 18 (see FIG. 3B) shaped like a substantially closed cylinder and serving as a support portion is integrally provided in the front and rear direction intermediate portion thereof, and the support shaft 18 extends rightward.

On the left wall of the plate 12, assembling claws 20 shaped like substantially long rectangular plates and serving as assembling portions are integrally provided above and below the support shaft 18, and the assembling claws 20 extend rightward. The upper and lower assembling claws 20 are arranged centrosymmetrically about the support shaft 18, and the assembling claws 20 are disposed perpendicularly to the up and down direction. On the distal end portions (right end portions) of the assembling claws 20, assembling projections 20A shaped like trapezoidal prisms are integrally provided, and the assembling projections 20A project toward the support shaft 18. The right faces of the assembling projections 20A are inclined in the direction of the support shaft 18 heading leftward, and the left faces of the assembling projections 20A are disposed perpendicularly to the left and right direction.

On the left wall of the plate 12, a regulating plate 24 shaped like a substantially rectangular plate and configuring a regulating mechanism 22 is integrally provided forward of the support shaft 18, and the regulating plate 24 extends rightward and is disposed perpendicularly to the up and down direction. On the right portion of the regulating plate 24, a regulating projection 24A shaped like a rectangular plate and serving as a regulating portion is integrally provided, and the regulating projection 24A projects rearward. In the regulating plate 24, a rectangular cancellation hole 24B serving as a cancelling portion is formed leftward of the regulating projection 24A, and the cancelling hole 24B penetrates the regulating plate 24 in the up and down direction.

On the rear portion of the inside of the plate 12, a lever 26 shaped like a substantially rectangular prism and serving as a shift body is provided, and the lever 26 is long in the up and down direction. A central shaft 26A shaped like a substantially closed cylinder penetrates and is mated with the lower end portion of the lever 26, and the central shaft 26A is supported by the left plate 12A and the right plate 12B of the plate 12. The axial direction of the central shaft 26A coincides with the left and right direction, and the lever 26 is pivotable (movable) in a predetermined range in the front and rear direction about the central shaft 26A.

The upper portion of the lever 26 pivotably penetrates the upper wall of the plate 12 and the console, and the lever 26 is pivotally operable at its upper portion by an occupant (particularly the driver) of the vehicle. The lever 26 is disposed in an H position (home position) serving as a shift position (a predetermined shift position); when the lever 26 is operated forward from the H position, the lever 26 is disposed in an R position (reverse position) serving as a shift position, and when the lever 26 is operated rearward from the H position, the lever 26 is disposed in a D position (drive position) serving as a shift position.

On the lower end portion of the lever 26, an energizing tube 28 shaped like a substantially bottomed open cylinder is integrally provided, and the energizing tube 28 projects rearward and its inside opens rearward. An energizing pin 30 (moderating pin) shaped like a substantially closed cylinder and serving as an energizing member configuring an energizing mechanism 14 is fitted into the energizing tube 28, and the energizing pin 30 is movable in the front and rear direction along the energizing tube 28 and its rear face (distal end face) projects in a spherical shape. A spring (a compression coil spring; not shown in the drawings) serving as an energizing portion bridges the front face (bottom face) of the inside of the energizing tube 28 and the front face (base end face) of the energizing pin 30, and the spring energizes the energizing pin 30 rearward. The rear face of the energizing pin 30 is in contact with the retention face 16A of the energizing face 16 inside the plate 12 due to the energizing force of the spring, whereby the lever 26 is retained (energized) in the H position. When the lever 26 is operated forward or backward from the H position, the rear face of the energizing pin 30 is moved outward in the up and down direction from the retention face 16A of the energizing face 16 counter to the energizing force of the spring. When the action of the operating force on the lever 26 is canceled in a state in which the lever 26 has been operated from the H position, the rear face of the energizing pin 30 is moved to the retention face 16A of the energizing face 16 by the energizing force of the spring, and the lever 26 is pivoted (returned) to the H position.

On the lower end portion of the lever 26, a first gear 32 (see FIG. 3B) shaped like a substantially rectangular plate is integrally provided, and the first gear 32 projects forward and is disposed perpendicularly to the left and right direction. On the front end of the first gear 32 are formed plural first gear teeth 32A, and the plural first gear teeth 32A are arranged at equal intervals along the circumferential direction of the central shaft 26A.

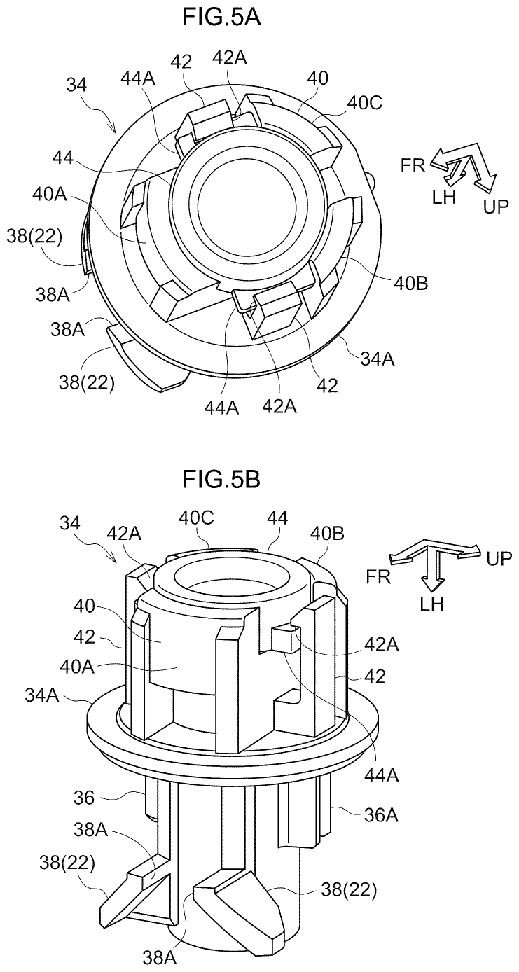

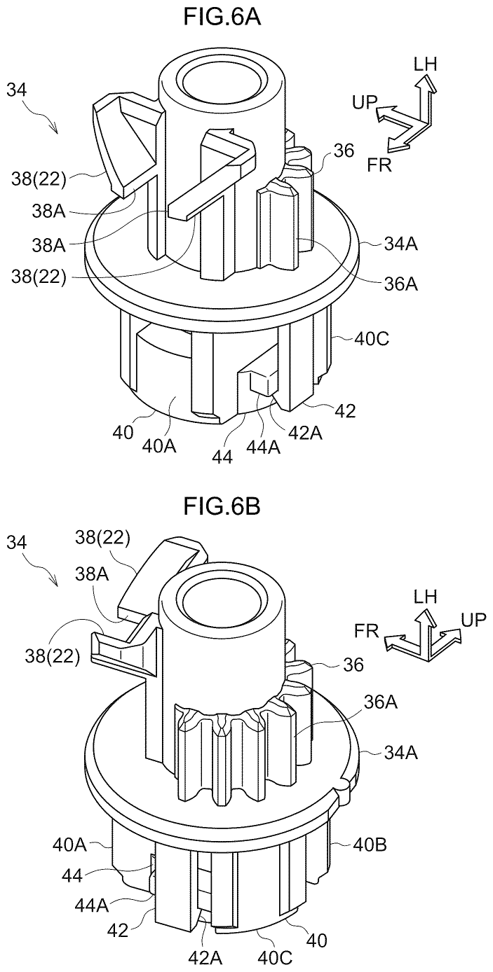

Inside the plate 12, a rotating body 34 (see FIG. 5A, FIG. 5B, FIG. 6A, and FIG. 6B) shaped like an open cylinder and serving as a moving body is provided on the front side of the lever 26.

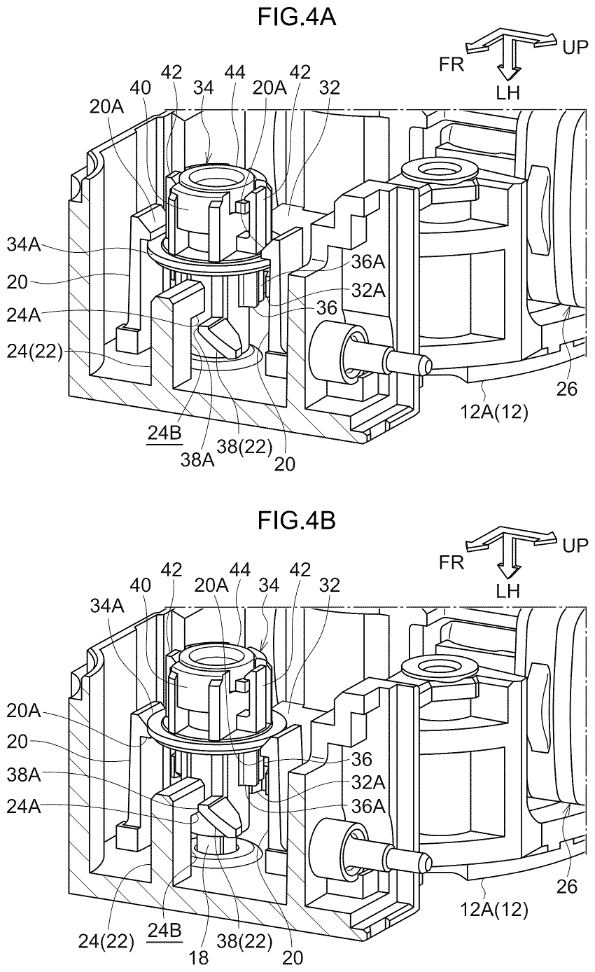

The support shaft 18 of the plate 12 is coaxially fitted from the left into the rotating body 34 (see FIG. 3B and FIG. 4A), and the rotating body 34 is rotatable (movable) about the support shaft 18. In the left and right direction intermediate portion of the rotating body 34, a disc-shaped assembling plate 34A serving as an assembled portion is integrally provided, and the assembling plate 34A is disposed coaxially with the rotating body 34. When the support shaft 18 is to be fitted into the rotating body 34, the assembling plate 34A is brought into abutting contact with the right faces of the assembling projections 20A of the assembling claws 20 of the plate 12 (see FIG. 4B), the assembling claws 20 are elastically deformed opposite from the rotating body 34, and thereafter the assembling plate 34A is passed through the assembling projections 20A, whereby the assembling claws 20 are elastically restored toward the rotating body 34, the left faces of the assembling projections 20A are brought into abutting contact (surface-to-surface contact) with the assembling plate 34A, and the rotating body 34 is brought into abutting contact (surface-to-surface contact) with the left wall of the plate 12. For this reason, rightward movement of the assembling plate 34A is restricted by the assembling projections 20A, and leftward movement of the rotating body 34 is restricted by the left wall of the plate 12, whereby movement of the rotating body 34 in the left and right direction is arrested, and the rotating body 34 is assembled to the plate 12.

On the left part of the rotating body 34, a second gear 36 is integrally provided, and the second gear 36 is disposed on the left side of the assembling plate 34A. The second gear 36 is provided with plural second gear teeth 36A, and the plural second gear teeth 36A are arranged at equal intervals along the circumferential direction of the rotating body 34. The first gear teeth 32A of the first gear 32 of the lever 26 are inserted between the second gear teeth 36A (the second gear teeth 36A may also be inserted between the first gear teeth 32A), whereby the second gear teeth 36A mesh with the first gear teeth 32A, and the second gear 36 is coupled to the first gear 32, so that the rotating body 34 is coupled to the lever 26. For this reason, when the lever 26 is pivoted, the first gear 32 is pivoted and the second gear 36 is rotated, whereby the rotating body 34 is rotated. The rotating body 34 is disposed in an H rotational position (a regulated position); when the lever 26 is pivoted from the H position to the R position, the rotating body 34 is rotated to an R rotational position, and when the lever 26 is pivoted from the H position to the D position, the rotating body 34 is rotated to a D rotational position.

On the front part of the left end portion of the rotating body 34, regulating pieces 38 shaped like substantially rectangular plates and serving as regulated portions and guide portions configuring the regulating mechanism 22 are integrally provided on the upper portion and the lower portion thereof, and the regulating pieces 38 are inclined in a direction toward the up and down direction central side of the rotating body 34 heading rightward. In the right end portions of the regulating pieces 38 are formed rectangular regulating faces 38A, and the regulating faces 38A of the upper and lower regulating pieces 38 are disposed perpendicularly to the up and down direction and oppose each other in the up and down direction. When the rotating body 34 is rotated, the regulating pieces 38 are passed through the cancellation hole 24B of the regulating plate 24 of the plate 12 and rotation of the rotating body 34 is allowed (see FIG. 4A). While the support shaft 18 of the plate 12 is in the middle of being fitted into the rotating body 34 (while the rotating body 34 is in the middle of being assembled to the plate 12), the regulating projection 24A of the regulating plate 24 is mated between the upper and lower regulating faces 38A (see FIG. 4B), the rotational position of the rotating body 34 is regulated to the H rotational position, and the insertion of one of the first gear teeth 32A into the center between the second gear teeth 36A (or the insertion of one of the first gear teeth 32A into the center between the second gear teeth 36A) is started.

A restricting tube 40 shaped like a substantially bottomed open cylinder and serving as a restricting portion is formed coaxially on the right end portion of the rotating body 34; the restricting tube 40 is larger in diameter relative to the part of the rotating body 34 on the left side of the restricting tube 40, and its inside opens rightward. The peripheral wall of the restricting tube 40 is divided into a front peripheral wall 40A on the front side and the up and down direction central side, an upper peripheral wall 40B on the rear side and the upper side, and a lower peripheral wall 40C on the rear side and the lower side, and the front end face of the upper peripheral wall 40B and the front end face of the lower peripheral wall 40C are disposed perpendicularly to the front and rear direction and are flush with each other.

On the right portion of the rotating body 34, mounting claws 42 shaped like substantially long rectangular plates and serving as mounting portions are integrally disposed on the upper portion and the lower portion thereof, and the mounting claws 42 extend rightward from the left side of the restricting tube 40. The mounting claws 42 are disposed between the front peripheral wall 40A and the upper peripheral wall 40B of the restricting tube 40 and between the front peripheral wall 40A and the lower peripheral wall 40C of the restricting tube 40, and the mounting claws 42 are disposed perpendicularly to the up and down direction. On the distal end portions (right end portions) of the mounting claws 42, mounting projections 42A shaped like trapezoidal prisms are integrally provided, and the mounting projections 42A project toward the central axis of the rotating body 34. The right faces of the mounting projections 42A are inclined toward the central axis of the rotating body 34 heading leftward, and the left faces of the mounting projections 42A are disposed perpendicularly to the left and right direction.

A substantially disc-shaped magnet 44 serving as a detected portion is coaxially inserted into the restricting tube 40 of the rotating body 34, and the magnet 44 is mated with the inside of the restricting tube 40 such that radial direction movement thereof is restricted. On the upper portion and the lower portion of the left end portion of the magnet 44, mounting prisms 44A shaped like substantially rectangular prisms and serving as mounted portions are integrally provided, and the upper and lower mounting prisms 44A project upward and downward, respectively. The mounting prisms 44A extend in the front and rear direction, and the left faces of the mounting prisms 44A are flush with the left face of the magnet 44. The upper and lower mounting prisms 44A are arranged centrosymmetrically about the central axis of the magnet 44, and the upper face of the upper mounting prism 44A and the lower face of the lower mounting prism 44A are disposed perpendicularly to the up and down direction. The rear face of the upper mounting prism 44A and the rear face of the lower mounting prism 44A are disposed perpendicularly to the front and rear direction and are flush with each other, and the rear face of the upper mounting prism 44A and the rear face of the lower mounting prism 44A are in surface-to-surface contact with the front end face of the upper peripheral wall 40B and the front end face of the lower peripheral wall 40C of the restricting tube 40, respectively. For this reason, movement (rotation) of the magnet 44 in its circumferential direction is restricted.

When the magnet 44 is inserted into the restricting tube 40, the mounting prisms 44A are brought into abutting contact with the right faces of the mounting projections 42A of the mounting claws 42 of the rotating body 34, the mounting claws 42 become elastically deformed opposite from the magnet 44, and thereafter the mounting prisms 44A are passed through the mounting projections 42A, whereby the mounting claws 42 are elastically restored toward the magnet 44, the left faces of the mounting projections 42A are brought into abutting contact (surface-to-surface contact) with the mounting prisms 44A, and the magnet 44 is brought into abutting contact (surface-to-surface contact) with the left face (bottom face) of the inside of the restricting tube 40. For this reason, rightward movement of the mounting prisms 44A is restricted by the mounting projections 42A, and leftward movement of the magnet 44 is restricted by the left face of the inside of the restricting tube 40, whereby movement of the magnet 44 in its axial direction (the left and right direction) is restricted, and the magnet 44 is mounted to the rotating body 34.

In this way, movement of the magnet 44 in its radial direction, circumferential direction, and axial direction relative to the rotating body 34 is restricted, whereby the magnet 44 is positioned in the rotating body 34, and when the rotating body 34 is rotated, the magnet 44 is rotated integrally with the rotating body 34, and the direction of the magnetic field generated by the magnet 44 is rotated.

Inside the plate 12, a circuit board 46 (see FIG. 2A) shaped like a substantially rectangular plate and serving as a detection mechanism is secured on the right side of the rotating body 34, and the circuit board 46 is disposed perpendicularly to the left and right direction. A sensor 46A (see FIG. 2B) serving as a detection unit is provided on the left face of the circuit board 46, and the sensor 46A is disposed on the right side of the magnet 44 of the rotating body 34. The sensor 46A detects the direction of the magnetic field generated by the magnet 44 to detect the rotational position of the rotating body 34. The circuit board 46 (the sensor 46A) is electrically connected to a control device 48 of the vehicle, and the control device 48 is electrically connected to a transmission 50 (an automatic transmission) of the vehicle (see FIG. 2A). In the control device 48, the rotational positions (the H rotational position, the R rotational position, and the D rotational position) of the rotating body 34 are set (stored) before the rotating body 34 (the second gear 36) is coupled to the lever 26 (the first gear 32), and when the sensor 46A detects that the rotating body 34 has been rotated to the H rotational position, the R rotational position, or the D rotational position, it is detected by the control device 48 that the lever 26 has been pivoted to the H position, the R position, or the D position, respectively.

Next, the action of the present embodiment will be described.

In the shift device 10 having the above configuration, in the energizing mechanism 14 the rear face of the energizing pin 30 of the lever 26 is in contact with the retention face 16A of the energizing face 16 in the plate 12 due to the energizing force of the spring, whereby the lever 26 is retained (energized) in the H position, and when the lever 26 is pivoted forward or backward from the H position counter to the energizing force of the spring, the lever 26 is positioned in the R position or the D position, respectively.

Furthermore, the rotating body 34 (the second gear 36) is coupled to the lever 26 (the first gear 32), and when the lever 26 is pivoted, the rotating body 34 is rotated. Additionally, the sensor 46A of the circuit board 46 detects the rotational position of the rotating body 34 (the magnet 44), whereby the shift position of the lever 26 is detected by the control device 48. Because of this, when it is detected that the lever 26 has been disposed in the R position or the D position, the shift range of the transmission 50 is changed to the corresponding R range (reverse range) or D range (drive range) by the control of the control device 48.

In this connection, when the rotating body 34 is to be assembled to the plate 12, the support shaft 18 of the plate 12 is fitted into the rotating body 34, whereby the second gear teeth 36A of the second gear 36 of the rotating body 34 mesh with the first gear teeth 32A of the first gear 32 of the lever 26, and the rotating body 34 (the second gear 36) becomes coupled to the lever 26 (the first gear 32).

Here, when the rotating body 34 (the second gear 36) is coupled to the lever 26 (the first gear 32), the lever 26 is retained in the H position by the energizing mechanism 14, and in the regulating mechanism 22 the regulating projection 24A of the regulating plate 24 in the plate 12 is mated between the regulating faces 38A of the upper and lower regulating pieces 38 of the rotating body 34, and the rotational position of the rotating body 34 is regulated to the H rotational position. For this reason, because the rotating body 34 is coupled to the lever 26, the rotational position (the H rotational position) of the rotating body 34 and the shift position (the H position) of the lever 26 can be matched to each other. Because of this, the need for a calibration process to match the rotational position of the rotating body 34 detected by the sensor 46A and the shift position of the lever 26 with each other after the rotating body 34 has been coupled to the lever 26 can be eliminated, thus simplifying the manufacturing process of the shift device 10 and eliminating the need for equipment for the calibration process.

Moreover, when the rotating body 34 has been coupled to the lever 26, the mating of the regulating projection 24A of the regulating plate 24 between the regulating pieces 38 (the regulating faces 38A) of the rotating body 34 is cancelled, and the regulating pieces 38 are passable through the cancellation hole 24B of the regulating plate 24, whereby the rotating body 34 is rotatable. For this reason, the lever 26 can be pivoted to rotate the rotating body 34.

Furthermore, as described above, the energizing mechanism 14 energizes the lever 26 to the H position. For this reason, while the energizing mechanism 14 retains the lever 26 in the H position, the regulating mechanism 22 can regulate the rotational position of the rotating body 34 to the H rotational position to couple the rotating body 34 to the lever 26. Because of this, the need to separately retain the lever 26 in the H position can be eliminated, and the rotational position of the rotating body 34 can be easily matched to the shift position of the lever 26.

Moreover, before the regulating mechanism 22 regulates the rotational position of the rotating body 34 to the H rotational position, the left face of the upper or lower regulating piece 38 of the rotating body 34 is brought into abutting contact with the regulating projection 24A of the regulating plate 24, and the rotating body 34 is rotated (guided) to the H rotational position, whereby the regulating projection 24A becomes mated between the regulating faces 38A of the upper and lower regulating pieces 38, and the rotational position of the rotating body 34 is regulated to the H rotational position. For this reason, the regulating mechanism 22 can easily regulate the rotating body 34 to the H rotational position.

Furthermore, the regulating mechanism 22 regulates the rotating body 34 to the rotational position (the H rotational position) corresponding to the shift position (the H position) of the lever 26 so that one of the first gear teeth 32A of the lever 26 (the first gear 32) is disposed in the center between the second gear teeth 36A of the rotating body 34 (the second gear 36). For this reason, even if there is backlash between the first gear teeth 32A and the second gear teeth 36A, the precision of the match between the rotational position of the rotating body 34 and the shift position of the lever 26 can be increased, and the precision with which the control device 48 detects the shift position of the lever 26 can be increased.

Moreover, movement of the magnet 44 in its radial direction, circumferential direction, and axial direction relative to the rotating body 34 is restricted, and the magnet 44 is positioned in the rotating body 34. For this reason, the positional precision of the magnet 44 in the rotating body 34 can be increased, the precision of the match between the rotational position of the rotating body 34 detected by the sensor 46A and the shift position of the lever 26 can be increased, and the precision with which the control device 48 detects the shift position of the lever 26 can be increased.

Furthermore, as described above, the rotating body 34 is rotated as a result of the lever 26 being pivoted. For this reason, the moving space of the rotating body 34 can be reduced, and the shift device 10 can be made more compact.

It will be noted that in the present embodiment the lever 26 is energized to the H position. However, the lever 26 may be energized to multiple shift positions.

Furthermore, in the present embodiment the lever 26 (the shift body) is pivoted. However, the shift body may also be slid (moved) or rotated (moved) about a central axis.

Moreover, in the present embodiment the rotating body 34 (the moving body) is rotated about its central axis. However, the moving body may also be pivoted (moved) or slid (moved).

Furthermore, in the present embodiment the shift device 10 is installed in the console of the vehicle. However, the shift device 10 may be installed in another part of the vehicle (e.g., an instrument panel or a steering column).

The disclosure of Japanese Patent Application No. 2023-70457, filed on Apr. 21, 2023, is incorporated in its entirety by reference herein.

### REFERENCE SIGNS LIST

10: Shift Device, 14: Energizing Mechanism, 22: Regulating Mechanism, 26: Lever (Shift Body), 32A: First Gear Teeth, 34: Rotating Body (Moving Body), 36A: Second Gear Teeth, 44: Magnet (Detected Portion), 46: Circuit Board (Detection Mechanism)

1. A shift device, comprising:
a shift body having a shift position that is changed when the shift body is moved;
a moving body that is coupled to the shift body and that is moved as a result of the shift body being moved;
a detection mechanism that detects a moving position of the moving body to thereby detect the shift position of the shift body; and
a regulating mechanism that regulates the moving body to a moving position corresponding to the shift position of the shift body when the shift body and the moving body are coupled.

2. The shift device of claim 1, wherein, when the shift body and the moving body have been coupled, regulation of the moving position of the moving body by the regulating mechanism is cancelled.

3. The shift device of claim 1, wherein the shift device includes an energizing mechanism that energizes the shift body to the shift position.

4. The shift device of any one of claim 1, wherein, before the regulating mechanism regulates the moving position of the moving body, the moving body is guided to the moving position corresponding to the shift position of the shift body.

5. The shift device of claim 4, wherein, before the regulating mechanism regulates the moving position of the moving body, the moving body is guidable from both moving direction sides of the moving position corresponding to the shift position of the shift body.

6. The shift device of any one of claim 1, wherein the shift device includes:
first gear teeth that are provided at a shift body side and
second gear teeth that are provided at a moving body side and that mesh with the first gear teeth,
wherein the regulating mechanism regulates the moving body to the moving position corresponding to the shift position of the shift body so that one of the first gear teeth is disposed in a center between the second gear teeth or one of the second gear teeth is disposed in a center between the first gear teeth.

7. The shift device of any one of claim 1, wherein the shift device includes a detected portion that is positioned in the moving body and that is detected by the detection mechanism to detect the moving position of the moving body.

8. The shift device of any one of claim 1, wherein the moving body is rotated as a result of the shift body being moved.

9. The shift device of claim 8, wherein the moving body is rotatably supported, and the shift body so that the moving body are coupled.

10. The shift device of any one of claim 1, wherein the shift device includes a support body by which the shift body is movably supported and the moving body is movably supported.
